(19) United States
(12) Patent Application Publication
(10) Pub. No.: US 2024/0355518 A1
(43) Pub. Date: Oct. 24, 2024

(54) Magnetorheological Fluid

(71) Applicant: SEIKO EPSON CORPORATION, Tokyo (JP)

(72) Inventor: Takeshi YANO, Fujimi (JP)

(21) Appl. No.: 18/637,523

(22) Filed: Apr. 17, 2024

(30) Foreign Application Priority Data
Apr. 18, 2023 (JP) 2023-067905

(51) Int. Cl. H01F 1/44

(52) U.S. Cl. CPC H01F 1/447

(57) ABSTRACT

A magnetorheological fluid contains: a dispersoid containing magnetic metal particles; and a liquid dispersion medium. A boiling point of a main component of the dispersion medium is 100° C. or higher and 235° C. or lower. An inter-coordinate distance between HSP coordinates of the magnetic metal particles and HSP coordinates of the main component of the dispersion medium is 13 or less. The magnetic metal particles may have an average particle diameter of 0.5 μm or more and 15.0 μm or less.

The present application is based on, and claims priority from JP Application Serial Number 2023-067905, filed Apr. 18, 2023, the disclosure of which is hereby incorporated by reference herein in its entirety.

### BACKGROUND

### 1. Technical Field

The present disclosure relates to a magnetorheological fluid.

### 2. Related Art

The magnetorheological fluid is, for example, a fluid obtained by dispersing magnetic metal particles in a dispersion medium. When a magnetic field is applied to the magnetorheological fluid, the magnetic metal particles are magnetized and aligned in a magnetic field direction. Accordingly, a chain-shaped cluster is formed, and viscosity of the fluid is changed. Therefore, utilization of a vibration control apparatus, a braking apparatus, or the like utilizing a change in the viscosity is studied.

In these apparatuses, for example, application and removal of a magnetic field are repeated to adjust the viscosity of the magnetorheological fluid, thereby implementing various functions such as vibration control and braking.

For example, JP-A-10-032114 discloses a magnetorheological fluid in which magnetic metal particles made of an alloy containing Fe and particles of fumed silica are dispersed in a liquid containing a poly-α-olefin. JP-A-10-032114 also discloses that the magnetic metal particles are particles having a bimodal distribution. The bimodal distribution refers to a distribution of diameters having two different maximum values. JP-A-10-032114 discloses that yield stress of the magnetorheological fluid can be controlled in a wide range by controlling the fraction of small particles and large particles constituting the bimodal distribution.

JP-A-10-032114 is an example of the related art.

In the magnetorheological fluid described in JP-A-10-032114, a combination of magnetic metal particles and a dispersion medium is not particularly considered. Therefore, regarding the magnetorheological fluid described in JP-A-10-032114, there is room for improvement in terms of dispersion stability of the magnetic metal particles. The viscosity of the magnetorheological fluid may change during storage. Therefore, it is an object to obtain a magnetorheological fluid that contains magnetic metal particles with high dispersion stability and has a small temporal change in viscosity.

### SUMMARY

A magnetorheological fluid according to an application example of the present disclosure includes:
a dispersoid containing magnetic metal particles; and
a liquid dispersion medium, in which
a boiling point of a main component of the dispersion medium is 100° C. or higher and 235° C. or lower, and
an inter-coordinate distance between HSP coordinates of the magnetic metal particles and HSP coordinates of the main component of the dispersion medium is 13 or less.

### BRIEF DESCRIPTION OF THE DRAWINGS

FIG. 1 is a schematic diagram showing a magnetorheological fluid according to an embodiment.

FIG. 2 is a cross-sectional view schematically showing a magnetic metal particle shown in FIG. 1.

### DESCRIPTION OF EMBODIMENTS

Hereinafter, a magnetorheological fluid according to the present disclosure will be described in detail based on embodiments shown in the accompanying drawings.

First, a magnetorheological fluid according to an embodiment will be described.

### 1. Magnetorheological Fluid

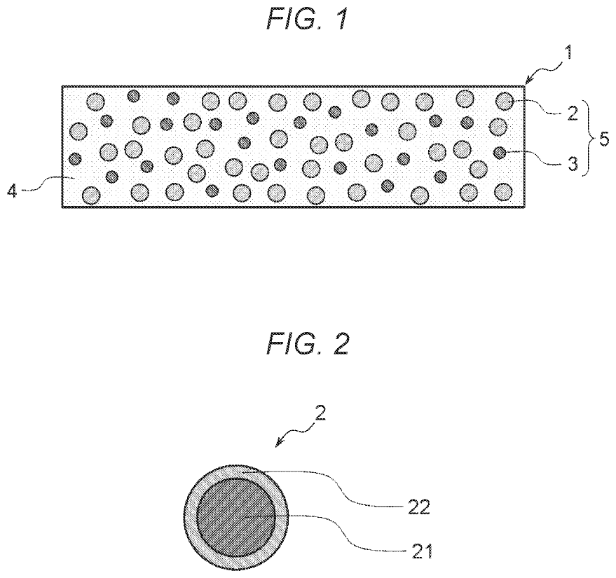

FIG. 1 is a schematic diagram showing a magnetorheological fluid 1 according to the embodiment. The magnetorheological fluid 1 shown in FIG. 1 contains a dispersoid 5 and a dispersion medium 4. The dispersoid 5 contains magnetic metal particles 2 and an additive 3, and is dispersed in the liquid dispersion medium 4.

The magnetorheological fluid 1 behaves like a liquid when no magnetic field is applied, and behaves like a semi-solid when a magnetic field is applied. The stress of the magnetorheological fluid 1 can be controlled by utilizing such a change in viscosity. Accordingly, the magnetorheological fluid 1 can be used for various apparatuses and the like that exhibit various functions by utilizing a change in stress.

### 1.1 Characteristics of Magnetorheological Fluid

### 1.1.1. Boiling Point of Dispersion Medium

In the magnetorheological fluid 1 according to the embodiment, a boiling point of a main component of the dispersion medium 4 is 100° C. or higher and 235° C. or lower, preferably 140° C. or higher and 230° C. or lower, and more preferably 160° C. or higher and 220° C. or lower. According to such a configuration, the boiling point of the main component of the dispersion medium 4 is optimized, and therefore, an increase in a volatilization amount of the dispersion medium 4 or an excessive increase in the viscosity of the dispersion medium 4 can be prevented. Accordingly, the dispersion stability of the magnetic metal particles 2 for the dispersion medium 4 can be enhanced.

When the dispersion medium 4 is made of a single liquid component, the main component of the dispersion medium 4 refers to the liquid component. When the dispersion medium 4 is made of a plurality of liquid components, the main component of the dispersion medium 4 refers to a liquid component having the largest volume ratio.

When the boiling point of the main component of the dispersion medium 4 is lower than the lower limit, the dispersion medium 4 is likely to be volatilized, and accordingly, the dispersion stability of the magnetic metal particles 2 dispersed in the dispersion medium 4 decreases. In contrast, when the boiling point of the main component of the dispersion medium 4 exceeds the upper limit, the viscosity of the dispersion medium 4 increases, and therefore, the dispersion stability of the magnetic metal particles 2 decreases.

Note that the boiling point of the main component of the dispersion medium 4 is a boiling point at a normal pressure. The main component can be specified by component analysis for the dispersion medium 4. When the type of a solvent constituting the main component is known, a boiling point thereof may be the boiling point of the main component.

### 1.1.2. Distance Between HSP Coordinates of Magnetic Metal Particles and HSP Coordinates of Dispersion Medium

In the magnetorheological fluid 1 according to the embodiment, an inter-coordinate distance Ra between HSP coordinates of the magnetic metal particles 2 and HSP coordinates of the main component of the dispersion medium 4 is 13 or less, preferably 2 or more and 12 or less, and more preferably 4 or more and 11 or less. The HSP coordinates are obtained by dividing a solubility parameter SP value of each substance into three components, a dispersion term (OD), a polarity term (Op), and a hydrogen bond term (OH), and taking values of the respective components as coordinates in a three-dimensional space, and are also referred to as Hansen solubility parameters.

The HSP coordinates of the magnetic metal particles 2 are represented by (δ_{D1}, δ_{P1}, δ_{H1}), and the HSP coordinates of the main component of the dispersion medium 4 are represented by (δ_{D2}, δ_{P2}, δ_{H2}). In this case, the inter-coordinate distance Ra between the HSP coordinates of the magnetic metal particles 2 and the HSP coordinates of the main component of the dispersion medium 4 is determined by the following formula (1).

$$R {a}^{2} = 4 \times {( {δ}_{D 2} - {δ}_{D 1} )}^{2} + {( {δ}_{P 2} - {δ}_{P 1} )}^{2} + {( {δ}_{H 2} - {δ}_{H 1} )}^{2} \qquad ( 1 )$$

When the inter-coordinate distance Ra between the HSP coordinates of the magnetic metal particles 2 and the HSP coordinates of the main component of the dispersion medium 4 is within the above range, the affinity of the magnetic metal particles 2 for the dispersion medium 4 is increased. Therefore, the dispersion stability of the magnetic metal particles 2 for the dispersion medium 4 can be enhanced. Accordingly, the shear stress of the magnetorheological fluid 1 when no magnetic field is applied can be sufficiently reduced. As a result, the magnetorheological fluid 1 in which a variation range of the shear stress depending on the presence or absence of excitation is sufficiently large can be obtained.

When the inter-coordinate distance Ra exceeds the upper limit, the affinity of the magnetic metal particles 2 for the dispersion medium 4 decreases. Therefore, the dispersion stability of the magnetic metal particles 2 in the magnetorheological fluid 1 decreases. In contrast, the inter-coordinate distance Ra may be lower than the lower limit, but in this case, the options of substances used for the dispersion medium 4 are narrowed. Therefore, the dispersion medium 4 may be hardly obtained or an increase in cost may be caused.

As a definition and a calculation method of the Hansen solubility parameters, a method described in “https://www.pirika.com/HSP/JP/Examples/Docs/Material.html” is used. In addition, the Hansen solubility parameters are also described in “Hansen Solubility Parameters: A User's Handbook” written by Charles M. Hansen (CRC press, 2007).

The Hansen solubility parameters can be acquired from various databases, and can also be calculated by inputting a chemical structure of each substance to computer software. Examples of the software include HSPiP (Hansen Solubility Parameters in Practice) 4th Edition (4.1.07).

### 1.2. Configuration of Magnetorheological Fluid

As described above, the magnetorheological fluid 1 includes the magnetic metal particles 2, the additive 3, and the dispersion medium 4.

### 1.2.1. Configuration of Magnetic Metal Particles

Examples of a constituent material of the magnetic metal particles 2 include an Fe-based metal material, an Ni-based metal material, and a Co-based metal material. One kind of them may be used, or a composite material containing two or more kinds thereof may be used. A composite material of the metal-based magnetic material and an oxide-based magnetic material may be used. Among them, the Fe-based metal material is preferably used as the constituent material of the magnetic metal particles 2 from the viewpoint of high saturation magnetization.

The Fe-based metal material is a metal material containing Fe as a main component. The main component means that a content of Fe is the highest compared with contents of all elements in the Fe-based metal material. The content of Fe is preferably 50% or more in terms of an atomic ratio. The Fe-based metal material has a higher saturation magnetization and higher toughness and strength than ferrite or the like. Therefore, the Fe-based metal material is useful as a constituent material of the magnetic metal particles 2.

The Fe-based metal material may contain, in addition to Fe, an element that exhibits ferromagnetic properties alone, such as Ni or Co, and may contain at least one selected from the group consisting of Cr, Nb, Cu, Al, Mn, Mo, Si, Sn, B, C, P, Ti, and Zr in accordance with target properties. The Fe-based metal material may contain inevitable impurities as long as the effects of the embodiment are not impaired.

The inevitable impurities are impurities unintentionally mixed in raw materials or during production. Examples of the inevitable impurities include O, N, S, Na, Mg, and K.

The Fe-based metal material is not particularly limited, and examples thereof include, in addition to pure iron and carbonyl iron, Fe-based alloy materials such as an Fe—Si—Al based alloy like Sendust, Fe—Ni based, Fe—Co based, Fe—Ni—Co based, Fe—Si—B based, Fe—Si—Cr—B based, Fe—Si—B—C based, Fe—Si—B—Cr—C based, Fe—Si—Cr based, Fe—B based, Fe—P—C based, Fe—Co—Si—B based, Fe—Si—B—Nb based, Fe—Si—B—Nb—Cu based, Fe—Zr—B based, Fe—Cr based, and Fe—Cr—Al based alloys.

The constituent material of the magnetic metal particles 2 may be an amorphous metal material, a crystalline metal material, or a microcrystalline (nanocrystalline) metal material. Among them, an amorphous metal material or a microcrystalline metal material is preferably used. The microcrystalline metal material refers to a metal material in which microcrystalline crystals (nanocrystals) having a crystal particle size of 100 nm or less are present. These contribute to sufficiently lowering a coercive force of the dispersoid 5 and enhancing the dispersion stability of the magnetic metal particles 2 in the magnetorheological fluid 1. In addition, these have higher toughness and strength than, for example, metal oxides, and therefore, the magnetic metal particles 2 can be effectively prevented from being worn or damaged. As a result, the magnetorheological fluid 1 having a particularly stable viscosity variation range can be obtained.

Examples of the amorphous metal material include binary or multi-element Fe-based amorphous alloys such as Fe—Si—B based, Fe—Si—Cr—B based, Fe—Si—B—C based, Fe—Si—B—Cr—C based, Fe—Si—Cr based, Fe—B based, Fe—B—C based, Fe—P—C based, Fe—Co—Si—B based, Fe—Si—B—Nb based, and Fe—Zr—B based alloys, an Ni-based amorphous alloy such as Ni—Si—B based and Ni—P—B based alloys, and a Co-based amorphous alloy such as a Co—Si—B based alloy.

Examples of the microcrystalline metal material include Fe-based nanocrystal alloys such as Fe—Si—B—Nb—Cu-based, Fe—Zr—B-based, Fe—Hf—B-based, Fe—Nb—B-based, Fe—Zr—B—Co-based, Fe—Hf—B—Co-based, Fe—Nb—B—Co-based, and Fe—Si—B—P—Cu-based alloys.

A particularly preferable Fe-based metal material is an alloy material containing Fe as a main component and containing at least one kind selected from the group consisting of Si, Cr, B, C, Ni, Mn, and Cu. The Fe-based metal material has high saturation magnetization and high corrosion resistance. Therefore, the magnetic metal particles 2 by which the magnetorheological fluid 1 having high corrosion resistance and high excitation shear stress can be produced can be obtained by using such Fe-based alloy material.

A content of Si (silicon) in the Fe-based metal material is preferably 1.0 at % or more and 20.0 at % or less, more preferably 1.5 at % or more and 13.0 at % or less, and still more preferably 2.0 at % or more and 11.0 at % or less. Such an alloy has high permeability, and therefore, the saturation magnetization tends to increase. Accordingly, the magnetic metal particles 2, by which the magnetorheological fluid 1 having particularly high excitation shear stress and magnetic field responsiveness can be produced, can be obtained.

A content of B (boron) in the Fe-based metal material is preferably 5.0 at % or more and 16.0 at % or less, and more preferably 9.0 at % or more and 14.0 at % or less. B is an element for promoting amorphization, and contributes to forming a stable amorphous structure or microcrystalline structure in the magnetic metal particles 2.

A content of C (carbon) in the Fe-based metal material is preferably 0.5 at % or more and 5.0 at % or less, and more preferably 1.0 at % or more and 3.0 at % or less. C is an element for promoting amorphization, and contributes to forming a stable amorphous structure or microcrystalline structure in the magnetic metal particles 2.

A content of Cr (chromium) in the Fe-based metal material is preferably 1.0 at % or more and 20.0 at % or less, and more preferably 1.5 at % or more and 5.0 at % or less. When the content of Cr is within the above range, the corrosion resistance of the magnetic metal particles 2 can be enhanced.

A content of the impurities is preferably 1.0 at % or less in total. At this level, the effect of the magnetic metal particles 2 is not impaired even if impurities are contained.

The elements and composition of the magnetic metal particles 2 can be specified by ICP emission spectrometry defined in JIS G 1258:2014, spark emission spectrometry defined in JIS G 1253:2002, or the like. In addition, when the magnetic metal particles 2 are coated with a coating film or the like, measurement can be performed by the above-described method after removing the coating film or the like by a chemical or physical method. After the magnetic metal particles 2 are cut, cross sections may be analyzed by an analysis apparatus such as an electron probe micro analyzer (EPMA) or energy dispersive X-ray spectroscopy (EDX).

The magnetic metal particles 2 may be particles produced by any method. Examples of the production method include various atomization methods such as a water atomization method, a gas atomization method, and a rotating water flow atomization method, a pulverization method, and a carbonyl method. Among these methods, according to the atomization method, the magnetic metal particles 2 having a particle shape closer to a true sphere can be obtained. The magnetic metal particles 2 are less likely to aggregate.

FIG. 2 is a cross-sectional view schematically showing the magnetic metal particle 2 shown in FIG. 1.

The magnetic metal particle 2 shown in FIG. 2 has a particle body 21 and a coating film 22 provided on the surface thereof. The coating film 22 may be provided as necessary, or may be omitted. It is preferable that an entire surface of the particle body 21 is coated with the coating film 22, and only a part of the surface may be coated.

Examples of a constituent material of the coating film 22 include an inorganic compound such as an inorganic oxide, a coupling agent, a surfactant, and an organic compound derived from a polymer polymerization film. When an inorganic compound is used among these, the moisture absorption resistance and rust resistance of the magnetic metal particles 2 can be enhanced. Further, when an organic compound is used, the dispersion stability of the magnetic metal particles 2 for the dispersion medium 4 can be further enhanced.

Examples of the inorganic compound include a silicon oxide, an aluminum oxide, a titanium oxide, a vanadium oxide, a niobium oxide, a chromium oxide, a manganese oxide, a tin oxide, and a zinc oxide. One kind of these inorganic compounds may be used, or a mixture or a composite containing two or more kinds thereof may be used. Among them, the silicon oxide is preferably used from the viewpoint of chemical stability and the like. The silicon oxide is an oxide represented by a composition formula SiOₓ (0<x≤2), and is preferably SiO₂.

Examples of a method for forming the coating film 22 made of an inorganic compound include a wet formation method such as a sol-gel method and a dry formation method such as a vapor deposition method. Among them, a Stober method or an atomic layer deposition (ALD) method, which is a type of the sol-gel methods, can be preferably used. The Stober method is a method for forming monodisperse particles by hydrolysis of a metal alkoxide. For example, when the coating film 22 is formed of a silicon oxide, the silicon oxide can be generated by a hydrolysis reaction of a silicon alkoxide. Before the coating film 22 is formed, a cleaning process using water or an organic solvent may be performed on a surface of the particle body 21 as a base of the coating film 22.

As the coupling agent, a coupling agent having a hydrophobic functional group is preferably used. Accordingly, the above-described dispersion stability can be further enhanced.

Examples of the hydrophobic functional group include an aliphatic hydrocarbon group, a cyclic structure-containing group, a fluoroalkyl group, a fluoroaryl group, a nitro group, an acyl group, and a cyano group. In particular, an aliphatic hydrocarbon group or a cyclic structure-containing group is preferably used.

Examples of the aliphatic hydrocarbon group include branched or unbranched alkyl groups. The number of carbon atoms in the alkyl group is not particularly limited, and is preferably 1 or more and 12 or less, and more preferably 1 or more and 6 or less. Accordingly, the magnetic metal particles 2 that are particularly favorably dispersed in the oily dispersion medium 4 can be obtained.

The cyclic structure-containing group is a functional group having a cyclic structure. Examples of the cyclic structure-containing group include an aromatic hydrocarbon group, an alicyclic hydrocarbon group, and a cyclic ether group.

The aromatic hydrocarbon group is a residue obtained by removing a hydrogen atom from an aromatic hydrocarbon, and preferably has 6 or more and 20 or less carbon atoms. Examples of the aromatic hydrocarbon group include an aryl group, an alkylaryl group, an aminoaryl group, and a halogenated aryl group. Examples of the aryl group include a phenyl group, a tolyl group, a xylyl group, a naphthyl group, and an indenyl group. Examples of the alkylaryl group include a benzyl group, a methylbenzyl group, a phenethyl group, a methylphenethyl group, and a phenylbenzyl group.

The alicyclic hydrocarbon group is a residue obtained by removing a hydrogen atom from an alicyclic hydrocarbon, and preferably has 3 or more and 20 or less carbon atoms. Examples of the alicyclic hydrocarbon group include a cycloalkyl group and a cycloalkylalkyl group. Examples of the cycloalkyl group include a cyclopropyl group, a cyclobutyl group, a cyclopentyl group, and a cyclohexyl group. Examples of the cycloalkylalkyl group include a cyclopentylmethyl group and a cyclohexylmethyl group.

Examples of the cyclic ether group include an epoxy group, a 3,4-epoxycyclohexyl group, and an oxetanyl group.

The fluoroalkyl group is an alkyl group having 1 or more and 16 or less carbon atoms or a cycloalkyl group having 3 or more and 16 or less carbon atoms which has one or more fluorine substituents. In particular, the fluoroalkyl group is preferably a perfluoroalkyl group.

The fluoroaryl group is an aryl group having 6 or more and 20 or less carbon atoms which has one or more fluorine substituents. In particular, the fluoroaryl group is preferably a perfluoroaryl group.

An average thickness of the coating film 22 is preferably 1 nm or more and 500 nm or less, more preferably 3 nm or more and 300 nm or less, and still more preferably 20 nm or more and 100 nm or less. When the average thickness of the coating film 22 is within the above range, the coating film 22 can be prevented from becoming thicker than necessary while ensuring the function of the above-described coating film 22. Accordingly, deterioration in the magnetic characteristics of the magnetic metal particles 2 due to an excessively high ratio of the coating film 22 can be prevented while preventing aggregation and deterioration of the magnetic metal particles 2.

The average thickness of the coating film 22 is a value obtained by observing the cross section of the magnetic metal particle 2 with an electron microscope and averaging the film thicknesses of the coating film 22 at 10 or more positions.

### 1.2.2. Physical Properties of Magnetic Metal Particles

A saturation magnetization of the magnetic metal particles 2 is preferably 50 emu/g or more, and more preferably 100 emu/g or more. The saturation magnetization is a magnetization value in a case in which a magnetization exhibited by a magnetic material when a sufficiently large magnetic field is externally applied is constant regardless of the magnetic field. As the saturation magnetization of the magnetic metal particles 2 is increased, the function of a magnetic material can be sufficiently exhibited. Specifically, a movement speed of the magnetic metal particles 2 in the magnetic field can be increased, and therefore, the responsiveness to the magnetic field can be enhanced. In addition, viscosity variation range can be further expanded.

An upper limit of the saturation magnetization of the magnetic metal particles 2 is not particularly limited, and is preferably 250 emu/g or less, and more preferably 200 emu/g or less, from the viewpoint of ease of selection of a material suitable for a balance between performance and cost.

The saturation magnetization of the magnetic metal particles 2 can be measured by a vibrating sample magnetometer (VSM) or the like. A maximum applied magnetic field for measuring the saturation magnetization is, for example, 1194 [kA/m] (15 [kOe]) or more.

A coercive force of the magnetic metal particles 2 is preferably 1595 [A/m] or less (20 [De] or less), more preferably 1196 [A/m] or less (15 [Oe] or less), and still more preferably 797 [A/m] or less (10 [Oe] or less). The coercive force refers to a value of an external magnetic field in an opposite direction required to cause a magnetized magnetic material to return to a non-magnetized state. That is, the coercive force means a resistance force against an external magnetic field. The magnetic metal particles 2 having a coercive force within the above range have a small residual magnetization, and therefore, the magnetic metal particles 2 are hardly magnetized when a magnetic field is not applied. In contrast, the magnetic metal particles 2 have a high followability of magnetization to a change in the magnetic field because the magnetic metal particles 2 are magnetized when a magnetic field is applied. Therefore, the magnetorheological fluid 1 containing the magnetic metal particles 2 having such a low coercive force has excellent responsiveness to a change in the magnetic field. The magnetic metal particles 2 having such a low coercive force hardly aggregate when a magnetic field is not applied, and therefore, the magnetic metal particles 2 can be uniformly dispersed even if the magnetic metal particles 2 are contained in the dispersion medium 4 at a high concentration. Therefore, the magnetorheological fluid 1 has a sufficient low viscosity recovery property.

In addition, when the low viscosity recovery property is sufficient, the viscosity variation range can be sufficiently ensured between a time point when the magnetic field is applied and a time point when the magnetic field is removed. The hysteresis of the change in the viscosity can be kept small, and therefore, the viscosity variation range can be stabilized even when the application and removal of the magnetic field are repeated. Accordingly, the magnetorheological fluid 1 having good characteristics over a long period of time can be obtained. As a result, high performance and long-term reliability can be imparted to various apparatuses in which the magnetorheological fluid 1 is used.

A lower limit of the coercive force of the magnetic metal particles 2 is not particularly limited, and is 8 [A/m] or more (0.1 [Oe] or more) from the viewpoint of sufficiently preventing a variation in the coercive force between production lots.

The coercive force of the magnetic metal particles 2 is measured using, for example, a vibrating sample magnetometer (VSM). As the vibrating sample magnetometer, for example, TM-VSM1550HGC manufactured by Tamagawa Seisakusyo Co., Ltd. may be used. The maximum applied magnetic field for measuring the coercive force is, for example, 1194 [kA/m] (15 [kOe]). When the magnetic metal particles 2 are separated from the magnetorheological fluid 1, for example, a method for removing the dispersion medium 4 with an organic solvent such as normal hexane or acetone is used.

An average particle diameter of the magnetic metal particles 2 is preferably 0.5 μm or more and 15.0 μm or less, more preferably 1.0 μm or more and 12.0 μm or less, and still more preferably 2.0 μm or more and 9.0 μm or less. When the average particle diameter of the magnetic metal particles 2 is within the above range, aggregation and precipitation of the magnetic metal particles 2 in a state in which a magnetic field is not applied can be prevented. In addition, a decrease in the magnetic field responsiveness can be prevented.

When the average particle diameter of the magnetic metal particles 2 is smaller than the lower limit, the aggregation of the magnetic metal particles 2 is likely to occur depending on the constituent material of the magnetic metal particles 2 even in a state in which a magnetic field is not applied. In addition, the viscosity variation range may be reduced. In contrast, when the average particle diameter of the magnetic metal particles 2 exceeds the upper limit, the magnetic metal particles 2 may precipitate in the dispersion medium 4, and the dispersion stability of the magnetic metal: particles 2 in the magnetorheological fluid 1 may decrease depending on the constituent material of the magnetic metal particles 2.

The average particle diameter of the magnetic metal particles 2 can be determined based on a cumulative distribution curve obtained from a volume-based particle size distribution a laser measured by diffraction/scattering method. Specifically, in the cumulative distribution curve, a particle diameter D50 (median diameter) at which a cumulative value from a small diameter side is 50% is the average particle diameter of the magnetic metal particles 2. As an apparatus for measuring the particle size distribution by the laser diffraction/scattering method, for example, MT3300 series manufactured by MicrotracBEL Corp. may be used.

An average circularity of the magnetic metal particles 2 is preferably 0.78 or more and 1.00 or less, more preferably 0.80 or more and 0.98 or less, and still more preferably 0.82 or more and 0.97 or less. Accordingly, a specific surface area of the magnetic metal particles 2 is reduced, and therefore, formation of aggregates can be prevented. As a result, the viscosity variation range of the magnetorheological fluid 1 can be stabilized.

When the average circularity is smaller than the lower limit, the average circularity decreases, and therefore, the variation range of the viscosity magnetorheological fluid 1 may be reduced. In contrast, when the average circularity exceeds the upper limit, the degree of difficulty in production increases, and the production efficiency of the magnetorheological fluid 1 may decrease.

The average circularity of the magnetic metal particles 2 is measured as follows.

First, an image (secondary electron image) of the magnetic metal particles 2 is captured by a scanning electron microscope (SEM). Next, the obtained image is read into image processing software. As the image processing software, for example, image analysis type particle size distribution measurement software “Mac-View” manufactured by Moun-tec, or the like is used. The imaging magnification is adjusted to capture 50 to 100 particles in one image. Then, a plurality of images are acquired to obtain images of a total of 300 or more particles.

Next, the circularity of the images of 300 or more particles is calculated using software, and an average value is determined. The obtained average value is the average circularity of the magnetic metal particles 2. When a circularity is represented by e, an area of the particle images is represented by S, and a perimeter of the particle images is represented by L, the circularity e is determined by the following formula.

$$e = 4 π S / {L}^{2}$$

A content of the magnetic metal particles 2 is preferably 40 mass % or more and 95 mass % or less, more preferably 50 mass % or more and 90 mass % or less, and still more preferably 60 mass % or more and 85 mass % or less, based on the entire magnetorheological fluid 1. Accordingly, appropriate viscosity can be obtained in each of the magnetorheological fluids 1 at the time of applying the magnetic field and at the time of removing the magnetic field, and the viscosity variation range of the magnetorheological fluid 1 can be sufficiently increased.

### 1.2.3. Additive

Examples of the additive 3 include a precipitation inhibitor, a detergent, a dispersant, an antioxidant, an anti-wear agent, an extreme-pressure agent, a friction modifier, a surfactant, a thixotropy-imparting agent (thickener), and a viscosity-reducing agent. One kind of these additives may be used, or a mixture of two or more kinds thereof may be used.

Examples of the precipitation inhibitor include solid particles made of a non-magnetic material, such as fumed silica, a clay powder such as bentonite and hectorite, a resin powder, and an oxide powder. One kind of these precipitation inhibitors may be used, or a mixture of two or more kinds thereof may be used. The solid particles are particles of a non-magnetic material different in the constituent material from the magnetic metal particles 2, and prevent the precipitation of the magnetic metal particles 2. Accordingly, a decrease in the viscosity variation range can be prevented even if a period in which the magnetic field is not applied continues for a long time.

Examples of the constituent material of the resin powder include an acrylic resin, a styrene resin, a polyolefin resin, a polyester resin, a melamine resin, a benzoguanamine resin, a polyacrylonitrile resin, a polyamide resin, a polycarbonate resin, a phenolic resin, a urea resin, a fluororesin, a cellulose resin, a polyurethane resin, a vinyl chloride resin, a polyether resin, a silicone resin, and an alkyd resin.

Examples of the constituent material of the oxide powder include a silicon oxide, an aluminum oxide, a titanium oxide, a vanadium oxide, a niobium oxide, a chromium oxide, a manganese oxide, a tin oxide, and a zinc oxide.

An average particle diameter of the solid particles is, for example, 20 nm or more and 1500 nm or less. The particle diameter of the solid particles is an equivalent circle diameter of a particle image of solid particles observed with an electron microscope, and the average particle diameter of the solid particles can be obtained by averaging 50 or more particles.

A content of the solid particles is preferably 5.0 mass % or less, and more preferably 0.5 mass % or more and 3.0 mass % or less, based on the entire magnetorheological fluid 1. Accordingly, the precipitation of the magnetic metal particles 2 can be prevented without influencing the viscosity variation range, and the viscosity variation range for a long period of time can be stabilized. Therefore, the dispersion stability can be optimized by adding an appropriate additive 3.

Examples of the dispersant include oleic acid salts, naphthenic acid salts, sulfonic acid salts, phosphoric acid esters, stearic acid, stearic acid salts, glycerol monooleate, sorbitan sesquioleate, lauric acid, fatty acids, and fatty alcohols.

Examples of the anti-wear agent include organic molybdenum compounds such as molybdenum dialkyldithiocarbamates and molybdenum dialkyldithiophosphates, and organic zinc compounds such as zinc dialkyldithiocarbamates and zinc dialkyldithiophosphates.

A total content of the additive 3 is preferably 10 mass % or less, more preferably 8 mass % or less, and still more preferably 6 mass % or less, based on the entire magnetorheological fluid 1. Accordingly, the additive 3 can be prevented from inhibiting the function of the magnetic metal particles 2.

The additive 3 may be added as necessary, or may be omitted.

### 1.2.4. Dispersion Medium

The dispersion medium 4 is not particularly limited as long as it contains a liquid having a boiling point within the above-described range as a main component. The main component of the dispersion medium 4 is required to satisfy the above-described boiling point range and the above-described inter-coordinate distance Ra is required to satisfy a predetermined range. Therefore, the main component of the dispersion medium 4 is determined in accordance with the kind of the magnetic metal particles 2, and a polar solvent is preferably used. When a polar solvent is contained, the dispersion medium 4 can particularly enhance the dispersion stability of the magnetic metal particles 2 made of an inorganic material.

Examples of the polar solvent include a protic polar solvent and an aprotic polar solvent.

Examples of the protic polar solvent include: monohydric alcohols such as methanol, ethanol, butanol, 1-propanol, and 2-methyl-1-propanol; dihydric alcohols such as ethylene glycol, propylene glycol, 1,3-propanediol, 2,3-butanediol, 1,4-butanediol, and 1,3-butanediol; and trihydric alcohols such as glycerin and butanetriol.

Examples of the aprotic polar solvent include: amides such as N-methyl-2-pyrrolidone (NMP), 3-methoxy-N,N-dimethylpropanamide, N,N-dimethyl formamide (DMF), N,N-dimethylpropionic amide, N,N-dimethylacetamide (DMA), N,N-diethylacetamide, 3-butoxy-N,N-dimethylpropanamide, and N,N-dibutylformamide; ureas such as 1,3-dimethyl-2-imidazolidinone, N,N′-dimethylpropylene urea, and 1,3-dimethoxy-1,3-dimethylurea; ethers such as propylene glycol monomethyl ether (PGME), propylene glycol monoethyl ether, diethylene glycol dimethyl ether, ethylene glycol diethyl ether, diethylene glycol diethyl ether, diethylene glycol dibutyl ether, dipropylene glycol monomethyl ether, and 1,3-butylene glycol-3-monomethyl ether; acetates as propylene glycol monomethyl ether acetate (PGMEA); ketones such as 2-heptanone; sulfones such as dimethyl sulfoxide (DMSO); and esters such as methyl pyruvate, ethyl pyruvate, and methyl-3-methoxypropionate.

As the dispersion medium 4, one kind or a combination of two or more kinds of the above specific examples can be used.

A content of the above main component in the dispersion medium 4 may be larger than those of other components, and is preferably 30 volume % or more, more preferably 50 volume % or more, still more preferably 70 volume % or more, and particularly preferably 90 volume % or more, based on the dispersion medium 4. Accordingly, the influence of the main component is in the dispersion medium 4, and therefore, the dispersion stability of the magnetic metal particles 2 can be particularly enhanced.

The dispersion medium 4 may contain a component other than the above main component.

Examples of the other component include: oils such as silicone oil, poly-α-olefin base oil, aromatic synthetic oil, paraffin oil, alkylated phenyl ether oil, ether oil, ester oil, polybutene oil, polyalkylene glycols, mineral oil, vegetable oil, and animal oil; organic solvents such as toluene, xylene, and hexane; and ionic liquids (ambient temperature molten salts) such as ethylmethylimidazolium salt, 1-butyl-3-methylimidazolium salt, and 1-methylpyrazolium salt.

Among them, examples of the ester oil include diesters produced from a monohydric alcohol and a dicarboxylic acid, polyol esters produced from a polyol and a monocarboxylic acid, and complex esters produced from a polyol, a monocarboxylic acid, and a polycarboxylic acid.

Examples of the diesters include esters of dibasic acids such as adipic acid, azelaic acid, sebacic acid, and dodecanedioic acid. The dibasic acid is preferably an aliphatic dibasic acid having 4 to 36 carbon atoms. The alcohol residue constituting the ester moiety of the dibasic acid ester is preferably a monohydric alcohol residue having 4 to 26 carbon atoms. Examples of such diesters include dioctyl adipate, dioctyl sebacate, diisodecyl adipate, and dioctyl azelate.

Specific examples of the polyol used for the polyol ester and the complex ester include hindered alcohols having no β-hydrogen, such as trimethylolpropane, pentaerythritol, and neopentyl glycol. Examples of the monocarboxylic acid used for the polyol ester and the complex ester include a coconut oil fatty acid, a straight chain saturated fatty acid such as stearic acid, a straight chain unsaturated fatty acid such as oleic acid, and a branched fatty acid such as isostearic acid.

As the polycarboxylic acid, a straight chain saturated polycarboxylic acid such as succinic acid, glutaric acid, adipic acid, pimelic acid, suberic acid, azelaic acid, and sebacic acid is preferably used.

Examples of the alkylated phenyl ether oil include alkylated diphenyl ether and (alkylated) polyphenyl ether.

Examples of the polyalkylene glycols include polyethylene glycol, polypropylene glycol, polybutylene glycol, an ethylene oxide-propylene oxide copolymer, a propylene oxide-butylene oxide copolymer, and derivatives thereof.

### 1.3. Example of Use of Magnetorheological Fluid

Examples of the use of the magnetorheological fluid 1 include various apparatuses and devices utilizing a difference between stress when application of a magnetic field is switched. Examples of such an apparatus or a device include a vibration control apparatus such as a linear damper, a rotary damper, or a shock absorber, a braking apparatus such as a brake, a power transmission apparatus such as a clutch, a muscle part or an end effector of a robot, a valve for controlling a liquid flow rate, a tactile presentation apparatus, an acoustic apparatus, a medical/welfare robot hand, a nursing hand, and personal mobility.

### 1.4. Method for Producing Magnetorheological Fluid

In a method for producing the magnetorheological fluid 1, first, raw materials of the magnetorheological fluid 1 described above are mixed and stirred. Examples of a stirring method include stirring with a spatula, a vortex mixer, a high shear mixer, and a low-frequency acoustic resonance mixer. The stirring time is appropriately set in accordance with the stirring method, and is preferably 5 minutes or longer and 4 hours or shorter. The stirring temperature is appropriately set in accordance with the stirring method, and is preferably 15° C. or higher and 70° C. or lower.

### 2. Effects of Embodiment

As described above, the magnetorheological fluid 1 according to the above embodiment includes the dispersoid 5 containing the magnetic metal particles 2, and the liquid dispersion medium 4. The boiling point of the main component of the dispersion medium 4 is 100° C. or higher and 235° C. or lower. The inter-coordinate distance Ra between the HSP coordinates of the magnetic metal particles 2 and the HSP coordinates of the main component of the dispersion medium 4 is 13 or less.

According to such a configuration, the boiling point of the main component of the dispersion medium 4 is optimized, and therefore, an increase in a volatilization amount of the dispersion medium 4 or an excessive increase in the viscosity of the dispersion medium 4 can be prevented. The inter-coordinate distance Ra between the HSP coordinates is optimized, and therefore, the affinity of the magnetic metal particles 2 for the dispersion medium 4 can be enhanced. Accordingly, the magnetorheological fluid 1 in which the dispersion stability of the magnetic metal particles 2 for the dispersion medium 4 is enhanced can be obtained.

The average particle diameter of the magnetic metal particles 2 is preferably 0.5 μm or more and 15.0 μm or less.

According to such a configuration, the magnetorheological fluid 1 in which aggregation or precipitation of the magnetic metal particles 2 in a state in which a magnetic field is not applied is prevented can be obtained. In addition, a decrease in magnetic field responsiveness of the magnetorheological fluid 1 can be prevented.

The boiling point of the main component of the dispersion medium 4 is preferably 160° C. or higher and 230° C. or lower. Further, the above-described inter-coordinate distance Ra is preferably 2 or more and 12 or less.

According to such a configuration, the magnetorheological fluid 1 in which the dispersion stability of the magnetic metal particles 2 for the dispersion medium 4 is particularly enhanced can be obtained.

The main component of the dispersion medium 4 is preferably a polar solvent.

Accordingly, the dispersion medium 4 can particularly enhance the dispersion stability of the magnetic metal particles 2 made of an inorganic material.

The magnetic metal particles 2 are preferably made of an Fe-based metal material. It is preferable that in the Fe-based metal material, a content of Fe is highest, and a content of Si is 1.0 at % or more and 20.0 at % or less.

The Fe-based metal material has higher permeability and saturation magnetization, and also has higher toughness and strength than ferrite or the like. Therefore, the Fe-based metal material is useful as a constituent material of the magnetic metal particles 2.

The Fe-based metal material is preferably an amorphous metal material or a microcrystalline metal material.

The Fe-based metal material has higher toughness and strength than for example, metal oxides or the like, and therefore, the magnetic metal particles 2 can be effectively prevented from being worn or damaged. As a result, the magnetorheological fluid 1 having a particularly stable viscosity variation range can be obtained.

The saturation magnetization of the magnetic metal particles 2 is preferably 50 emu/g or more and 250 emu/g or less.

Accordingly, the responsiveness of the magnetic metal particles 2 to a magnetic field can be enhanced.

Although the magnetorheological fluid according to the present disclosure has been described based on the preferred embodiment, the present disclosure is not limited thereto.

For example, the magnetorheological fluid according to the present disclosure may be obtained by adding any configuration to the above embodiment.

### EXAMPLE

Next, specific Examples of the present disclosure will be described.

### 3. Preparation of Magnetorheological Fluid

### 3.1. Example 1

First, magnetic metal particles and additives were dispersed in a dispersion medium to prepare a magnetorheological fluid. Configurations of the magnetorheological fluid are shown in Tables 1 and 2. A clay powder as solid particles and a liquid organic molybdenum compound were used as additives.

A content of the magnetic metal particles in the magnetorheological fluid was 85 mass %, a content of the solid particles was 2.0 mass %, a content of the organic molybdenum compound was 3.0 mass %, and the balance was a dispersion medium.

### 3.2. Examples 2 to 9

Magnetorheological fluids were obtained in the same manner as in Example 1 except that configurations of the magnetorheological fluids were changed as shown in Tables 1 and 2. An amorphous metal 1A shown in Table 1 is a core-shell particle having a particle body made of an amorphous metal represented by a composition formula shown in Table 1 and a coating film with which a surface of the particle body is coated. The coating film was a film made of a silicon oxide and formed by a Stober method, and had an average thickness of 60 nm. A crystalline metal 1 shown in Table 1 is stainless steel SUS 630 containing Fe as a main component, and containing Cr, Ni, Cu, and Nb in predetermined amounts and a small amount (1.0 mass % or less) of Si and Mn.

### 3.3. Comparative Examples 1 to 4

Magnetorheological fluids were obtained in the same manner as in Example 1 except that configurations of the magnetorheological fluids were changed as shown in Tables 1 and 2.

### 3.4. Examples 10 to 15

Magnetorheological fluids were obtained in the same manner as in Example 1 except that configurations of the magnetorheological fluids were changed as shown in Tables 1 and 3.

### 3.5. Comparative Example 5

Magnetorheological fluids were obtained in the same manner as in Example 1 except that configurations of the magnetorheological fluids were changed as shown in Tables 1 and 3.

### 6. Evaluation Results of Magnetorheological Fluid

The magnetorheological fluid of each of Examples and Comparative Examples was evaluated as follows.

### 6.1. Dispersion Stability

The dispersion stability of the magnetic metal particles of the magnetorheological fluid of each of Examples and Comparative Examples was evaluated by the following method.

First, 1 mL of a magnetorheological fluid was placed in a 1.5 mL sample bottle. After standing at 25° C. for 24 hours, a thickness tA of a magnetic particle-containing layer and a thickness tB of a dispersion medium layer (supernatant layer) were measured. The thickness of the magnetic particle-containing layer is a thickness of a layer made of precipitated magnetic particles, and the thickness of the dispersion medium layer is a thickness from an upper end of the magnetic particle-containing layer to a liquid surface.

Next, a supernatant ratio tB/(tA+tB) was calculated from the thicknesses tA and tB. Then, the dispersion stability of the magnetorheological fluid was evaluated by comparing the calculated supernatant ratio with the following evaluation criteria. The evaluation results are shown in Tables 2 and 3. It is shown that the smaller the supernatant ratio is, the higher the dispersion stability of the magnetic metal particles in the magnetorheological fluid is.

AA: The supernatant ratio is 5% or less

A: The supernatant ratio is more than 5% and 10% or less

B: The supernatant ratio is more than 10% and 30% or less

C: The supernatant ratio is more than 30%

### 6.2. Initial Stability

The viscosity of the magnetorheological fluid of each of Examples and Comparative Examples was measured. The shear rate during measurement was 0.033 [/s], and the temperature of the magnetorheological fluid was 25° C. In addition, a rheometer MCR102 manufactured by Anton Paar Japan K.K. was used for the measurement.

Then, the obtained measurement results were evaluated in view of the following evaluation criteria. The evaluation results are shown in Tables 2 and 3 as “initial viscosity”.

A: The initial viscosity is 500 mPa·s or less

B: The initial viscosity is more than 500 mPa·s and 1000 mPa·s or less

C: The initial viscosity is more than 1000 mPa·s

### 6.3. Temporal Change in Viscosity

The magnetorheological fluid of each of Examples and Comparative Examples was allowed to stand in an environment with a temperature of 35° C. for one day after being measured for the initial viscosity. Thereafter, the viscosity was measured again in the same manner as in 6.2. Then, the rate of increase in the viscosity was calculated based on the obtained measurement results and the above-described initial viscosity. The rate of increase in viscosity is a ratio of a difference obtained by subtracting the initial viscosity from the measurement results to the initial viscosity. The calculation results were evaluated in view of the following evaluation criteria. The evaluation results are shown in Tables 2 and 3 as “temporal change in viscosity”.

A: The rate of increase in viscosity is less than 5%

B: The rate of increase in viscosity is 5% or more and less than 10%

C: The rate of increase in viscosity is 10% or more

TABLE 1

| | Composition formula (atomic ratio) or steel type |
|---|---|
| Amorphous | (Fe_{0.97}Cr_{0.03})₇₆(Si_{0.5}B_{0.5})₂₂C₂ |
| metal 1 | |
| Amorphous | (Fe_{0.97}Cr_{0.03})₇₆(Si_{0.5}B_{0.5})₂₂C₂ + coating film |
| metal 1A | |
| Amorphous | Fe₇₉(Si_{0.3}B_{0.7})₁₉C₂ |
| metal 2 | |
| Crystalline | SUS630 |
| metal 1 | |
| Crystalline | Fe_{88.6}Si_{6.7}Cr_{4.7} |
| metal 2 | |

TABLE 2

| | Configuration of magnetorheological fluid | | | | | | | | | | | |
|---|---|---|---|---|---|---|---|---|---|---|---|---|
| | Magnetic metal particles | | | | | | Main component | | | | | |
| | | Average | | | | | of dispersion | | | Evaluation results | | |
| | | particle | Average | Saturation | | | medium | | Distance Ra | Disper- | | Temporal |
| | Magnetic | diameter | circu- | magneti- | Coercive | | Compo- | Boiling | between HSP | sion | Initial | change in |
| | material | D50 | larity | zation | force | | sition | point | coordinate | stability | stability | viscosity |
| | — | μm | — | emu/g | A/m | Oe | — | — | — | — | — | — |
| Example 1 | Amorphous | 10 | 0.89 | 144 | 239 | 3 | Dimethyl | 213 | 11 | B | A | B |
| | metal 1 | | | | | | sulfoxide | | | | | |
| | | | | | | | (DMSO) | | | | | |
| Example 2 | Amorphous | 7 | 0.87 | 143 | 399 | 5 | Dimethyl | 213 | 11 | A | A | B |
| | metal 1 | | | | | | sulfoxide | | | | | |
| | | | | | | | (DMSO) | | | | | |
| Example 3 | Amorphous | 2 | 0.85 | 141 | 558 | 7 | 1,3- | 213 | 11 | AA | A | B |
| | metal 1 | | | | | | propanediol | | | | | |
| Example 4 | Amorphous | 10 | 0.91 | 144 | 239 | 3 | 1,3- | 191 | 6 | B | A | A |
| | metal 1 | | | | | | propanediol | | | | | |
| Example 5 | Amorphous | 7 | 0.87 | 143 | 399 | 5 | 1,3- | 191 | 6 | A | A | A |
| | metal 1 | | | | | | propanediol | | | | | |
| Example 6 | Crystalline | 10 | 0.86 | 100 | 1515 | 19 | Isobutanol | 108 | 12 | B | A | B |
| | metal 1 | | | | | | | | | | | |
| Example 7 | Amorphous | 2 | 0.85 | 141 | 558 | 7 | Dimethyl | 191 | 7 | AA | A | B |
| | metal 1A | | | | | | sulfoxide | | | | | |
| | | | | | | | (DMSO) | | | | | |
| Example 8 | Crystalline | 10 | 0.86 | 100 | 1515 | 19 | Ethylene | 197 | 2 | B | A | B |
| | metal 1 | | | | | | glycol | | | | | |
| Example 9 | Amorphous | 10 | 0.89 | 144 | 239 | 3 | Isobutanol | 108 | 12 | B | A | B |
| | metal 1 | | | | | | | | | | | |
| Comparative | Crystalline | 10 | 0.86 | 100 | 1515 | 19 | 1,3- | 213 | 15 | C | A | B |
| Example 1 | metal 1 | | | | | | propanediol | | | | | |
| Comparative | Amorphous | 10 | 0.89 | 144 | 239 | 3 | Hexane | 69 | 23 | C | A | C |
| Example 2 | metal 3 | | | | | | | | | | | |
| Comparative | Amorphous | 10 | 0.89 | 144 | 239 | 3 | Ethanol | 78 | 10 | B | A | C |
| Example 3 | metal 1 | | | | | | | | | | | |
| Comparative | Amorphous | 10 | 0.89 | 144 | 239 | 3 | 1-phenoxy- | 243 | 10 | A | C | A |
| Example 4 | metal 1 | | | | | | 2-propanol | | | | | |

TABLE 3

| | Configuration of magnetorheological fluid | | | | | | | | | | | |
|---|---|---|---|---|---|---|---|---|---|---|---|---|
| | Magnetic metal particles | | | | | | Main component | | | | | |
| | | Average | | | | | of dispersion | | | Evaluation results | | |
| | | particle | Average | Saturation | | | medium | | Distance Ra | Disper- | | Temporal |
| | Magnetic | diameter | circu- | magneti- | Coercive | | Compo- | Boiling | between HSP | sion | Initial | change in |
| | material | D50 | larity | zation | force | | sition | point | coordinate | stability | stability | viscosity |
| | — | μm | — | emu/g | A/m | Oe | — | — | — | — | — | — |
| Example 10 | Amorphous | 1.0 | 0.89 | 144 | 239 | 3 | N,N- | 153 | 6 | B | A | B |
| | metal 1 | | | | | | dimethyl- | | | | | |
| | | | | | | | formamide | | | | | |
| | | | | | | | (DME) | | | | | |
| Example 11 | Amorphous | 4 | 0.91 | 210 | 80 | 1 | Dimethyl | 189 | 5 | A | A | A |
| | metal 2 | | | | | | sulfoxide | | | | | |
| | | | | | | | (DMSO) | | | | | |
| Example 12 | Crystalline | 6 | 0.82 | 190 | 558 | 7 | N,N- | 153 | 13 | B | A | B |
| | metal 2 | | | | | | dimethyl- | | | | | |
| | | | | | | | formamide | | | | | |
| | | | | | | | (DME) | | | | | |
| Example 13 | Crystalline | 6 | 0.82 | 190 | 558 | 7 | Ethylene | 197 | 2 | A | A | A |
| | metal 2 | | | | | | glycol | | | | | |
| Example 14 | Amorphous | 10 | 0.89 | 144 | 239 | 3 | Isobutanol | 108 | 12 | B | A | B |
| | metal 1 | | | | | | | | | | | |
| Example 15 | Crystalline | 8 | 0.82 | 190 | 558 | 7 | Isobutanol | 108 | 12 | B | A | B |
| | metal 2 | | | | | | | | | | | |
| Comparative | Crystalline | 6 | 0.82 | 190 | 558 | 7 | Dimethyl | 189 | 15 | C | A | B |
| Example 5 | metal 2 | | | | | | sulfoxide | | | | | |
| | | | | | | | (DMSO) | | | | | |

As is clear from Tables 2 and 3, it was confirmed that the magnetorheological fluid of each of Examples contained magnetic metal particles with high dispersion stability and had a small temporal change in viscosity.

What is claimed is:

1. A magnetorheological fluid comprising:
a dispersoid containing magnetic metal particles; and
a liquid dispersion medium, wherein
a boiling point of a main component of the dispersion medium is 100° C. or higher and 235° C. or lower, and
an inter-coordinate distance between HSP coordinates of the magnetic metal particles and HSP coordinates of the main component of the dispersion medium is 13 or less.

2. The magnetorheological fluid according to claim 1, wherein
the magnetic metal particles have an average particle diameter of 0.5 μm or more and 15.0 μm or less.

3. The magnetorheological fluid according to claim 1, wherein
the boiling point of the main component of the dispersion medium is 160° C. or higher and 230° C. or lower, and
the inter-coordinate distance is 2 or more and 12 or less.

4. The magnetorheological fluid according to claim 1, wherein
the main component of the dispersion medium is a polar solvent.

5. The magnetorheological fluid according to claim 1, wherein
the magnetic metal particles are made of an Fe-based metal material,
in the Fe-based metal material,
a content of Fe is highest, and
a content of Si is 1.0 at % or more and 20.0 at % or less.

6. The magnetorheological fluid according to claim 5, wherein
the Fe-based metal material is an amorphous metal material or a microcrystalline metal material.

7. The magnetorheological fluid according to claim 1, wherein
the magnetic metal particles have a saturation magnetization of 50 emu/g or more and 250 emu/g or less.
